(19) United States
(12) Patent Application Publication
(10) Pub. No.: US 2023/0059402 A1
(43) Pub. Date: Feb. 23, 2023

(54) METHOD, APPARATUS, AND SYSTEM FOR PROVIDING INCREASED ACCURACY FOR A POSITIONING RECEIVER IN A MULTIPATH SIGNAL ENVIRONMENT

(71) Applicant: HERE Global B.V., Eindhoven (NL)

(72) Inventor: Jan VAN SICKLE, Denver, CO (US)

(21) Appl. No.: 17/406,800

(22) Filed: Aug. 19, 2021

(51) Int. Cl. G01S 19/28; G01S 19/22; G01S 19/25; G01S 19/42

(52) U.S. Cl. CPC G01S 19/28; G01S 19/22; G01S 19/258; G01S 19/425

(57) ABSTRACT

An approach is provided for increased accuracy for a positioning receiver in a multipath signal environment. The approach, for example, involves receiving real-time imagery data collected using one or more sensors. The real-time imagery data, for instance, depicts a geographic environment in which the positioning receiver is operating. The approach also involves processing the real-time imagery data to dynamically generate a mask angle. The approach further involves blocking one or more signals from one or more navigation satellites received at the positioning receiver using the mask angle. The approach further involves determining positioning data using the positioning receiver based on the blocking of the one or more signals.

### BACKGROUND

Generally, Global Navigation Satellite Systems (GNSS) broadcast signals from multiple satellites to positioning receivers that compute positioning data (e.g., a location of a receiver) based on the timing of when signals for different satellites are received. However, in environments where a signal from one satellite can be bounced from surfaces or objects in the environment (e.g., environments with tall buildings or other structures), one signal can follow multiple paths to the receiver which can affect the accuracy of the positioning data determined by the receiver. This problem is commonly referred to as the “Urban Canyon and Obstruction Problem.” As a result, positioning receiver manufacturers and related location-based service providers face significant technical challenges with respect to reducing multipath signal interference that can affect the accuracy and reliability of positioning receivers.

### SOME EXAMPLE EMBODIMENTS

Therefore, there is a need for an approach for providing increased accuracy for a positioning receiver in a multipath signal environment, particularly for positioning receivers that move in real-time such as in vehicles or mobile devices (e.g., smartphones, personal navigation devices, etc.) where the environment is constantly changing.

According to one embodiment, a method comprises receiving real-time imagery data collected using one or more sensors. The real-time imagery data, for instance, depicts a geographic environment in which a positioning receiver is operating. The method also comprises processing the real-time imagery data to dynamically generate a mask angle (e.g., a minimum acceptable elevation above the horizon that a positioning satellite of GNSS has to be to have line-of-sight to the positioning receiver). The method further comprises blocking one or more signals from one or more navigation satellites received at the positioning receiver using the mask angle. The method further comprises determining positioning data using the positioning receiver based on the blocking of the one or more signals.

According to another embodiment, an apparatus comprises at least one processor, and at least one memory including computer program code for one or more computer programs, the at least one memory and the computer program code configured to, with the at least one processor, cause, at least in part, the apparatus to receive real-time imagery data collected using one or more sensors. The real-time imagery data, for instance, depicts a geographic environment in which a positioning receiver is operating. The apparatus is also caused to process the real-time imagery data to dynamically generate a mask angle (e.g., a minimum acceptable elevation above the horizon that a positioning satellite of GNSS has to be to have line-of-sight to the positioning receiver). The apparatus is further caused to block one or more signals from one or more navigation satellites received at the positioning receiver using the mask angle. The apparatus is further caused to determine positioning data using the positioning receiver based on the blocking of the one or more signals.

According to another embodiment, a non-transitory computer-readable storage medium carries one or more sequences of one or more instructions which, when executed by one or more processors, cause, at least in part, an apparatus to receive real-time imagery data collected using one or more sensors. The real-time imagery data, for instance, depicts a geographic environment in which a positioning receiver is operating. The apparatus is also caused to process the real-time imagery data to dynamically generate a mask angle (e.g., a minimum acceptable elevation above the horizon that a positioning satellite of GNSS has to be to have line-of-sight to the positioning receiver). The apparatus is further caused to block one or more signals from one or more navigation satellites received at the positioning receiver using the mask angle. The apparatus is further caused to determine positioning data using the positioning receiver based on the blocking of the one or more signals.

According to another embodiment, an apparatus comprises means for receiving real-time imagery data collected using one or more sensors. The real-time imagery data, for instance, depicts a geographic environment in which a positioning receiver is operating. The apparatus also comprises means for processing the real-time imagery data to dynamically generate a mask angle (e.g., a minimum acceptable elevation above the horizon that a positioning satellite of GNSS has to be to have line-of-sight to the positioning receiver). The apparatus further comprises means for blocking one or more signals from one or more navigation satellites received at the positioning receiver using the mask angle. The apparatus further comprises means for determining positioning data using the positioning receiver based on the blocking of the one or more signals.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing increased accuracy for a positioning receiver in a multipath environment, according to one embodiment;

FIGS. 2A and 2B are diagrams illustrating examples of using a dynamic mask angle to provide increased accuracy for a positioning receiver in a multipath environment, according to one embodiment;

FIG. 3 is a diagram of components of a mask angle application or platform capable of providing increased accuracy for a positioning receiver in a multipath environment, according to one embodiment;

FIG. 4 is a flowchart of a process for providing increased accuracy for a positioning receiver in a multipath environment, according to one embodiment;

FIG. 5 is a diagram illustrating an example of generating a dynamic mask angle for a positioning receiver in a moving vehicle, according to one embodiment;

FIG. 6 is a diagram illustrating an example of mapping user interface presenting positioning data generated based on providing increased accuracy for a positioning receiver in a multipath environment, according to one embodiment;

FIG. 7 is a diagram of a geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset) that can be used to implement an embodiment.

### DESCRIPTION OF SOME EMBODIMENTS

Examples of a method, apparatus, and computer program for providing increased accuracy for a positioning receiver in a multipath environment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

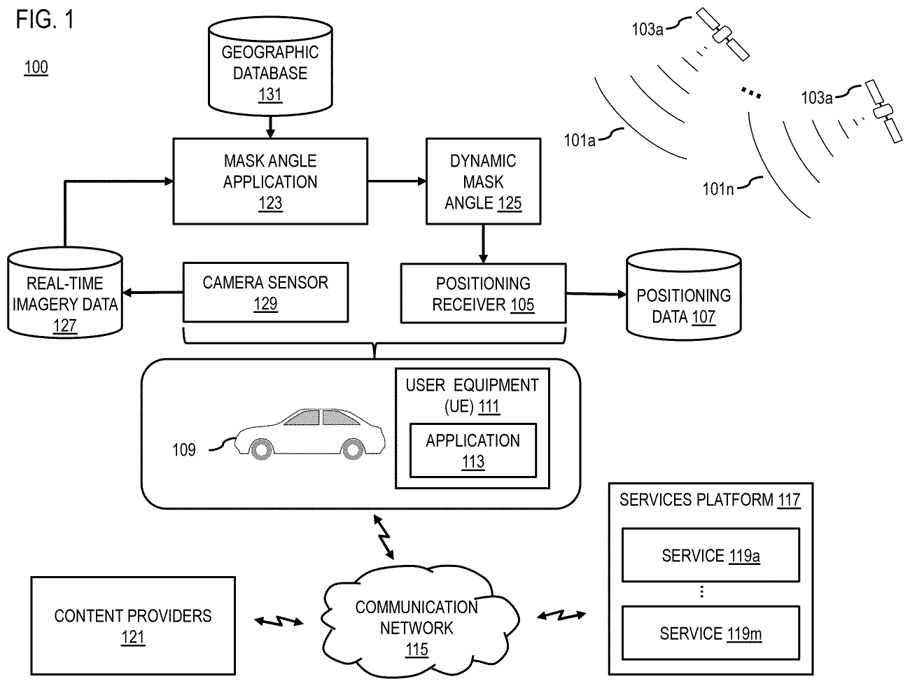

FIG. 1 is a diagram of a system capable of providing increased accuracy for a positioning receiver in a multipath environment, according to one embodiment. As described above, Global Navigation Satellite Systems (GNSS) generally operate by broadcasting signals (e.g., signals 101a-101n—also collectively referred to as signals 101) from positioning satellites (e.g., satellites 103a-103n—also collectively referred to as satellites 103) that are then received at a GNSS receiver (e.g., positioning receiver 105). The positioning receiver 105 then uses the known positions of the satellites 103 and the timing of when the signals 101 from those satellites 103 are received to compute a location of the positioning receiver 105 (e.g., positioning data 107 comprising a latitude, longitude, and optionally altitude). In one embodiment, when the positioning receiver 105 is equipped in a vehicle 109 or other device (e.g., a user equipment (UE) device 111), the positioning data 107 can be used to indicate the location of the corresponding vehicle 109 or UE 111.

In one embodiment, the positioning data 107 can then be used by any location-based service or application. By way of example, these location-based services and/or application can include but are not limited to: (1) location-based applications 113 (e.g., mapping and/or navigation applications) executing on the vehicle 109 and/or UE 111; (2) online location-based services (e.g., online or cloud-based mapping or navigation services) provided over a communication network 115 by a services platform 117 comprising one or more services 119a-119m (also collectively referred to as services 119) and/or other content providers 121.

These location-based services and applications generally on the accuracy of the positioning data 107 to provide their highest quality of service. Accordingly, if the accuracy or reliability the positioning data 107 is reduced, so is the quality of the location-based service and/or application. For example, in an urban canyon and obstruction problem scenario (e.g., also referred to as a multipath signal problem or environment), signals 101 from one or more satellites 103 can be obstructed or bounced off structures, objects, surfaces, etc. in the environment before being received at the positioning receiver 105. Bounced signals will have a longer path from the originating satellite 103 to the positioning receiver 105, then the timing for when the signal is broadcast from the satellite 103 to when the signal 101 is received at the positioning receiver 105 will also be longer than expected. This difference in signal timing can then result in increased error in computing the resulting positioning data 107. Accordingly, service providers face significant technical challenges with respect to mitigating the urban canyon and obstruction problem to improve the performance of positioning receivers 105.

To address these technical challenges, the system 100 of FIG. 1 introduces a capability to minimize the urban canyon and obstruction problem by providing a mask angle application 123 to generate a dynamic mask angle 125 that changes with the environment (e.g., in real-time) to substantially increase accuracy, reliability, and consistency of GNSS positions (e.g., positioning data 107) in obstructed situations. A mask angle, for instance, is a threshold elevation above the horizon such that any positioning signals 101 received at an angle below the threshold elevation would be blocked or otherwise filtered from use in computing the positioning data 107. In one embodiment, the system 100 uses real-time imagery data 127 captured using one or more sensors (e.g., camera sensor 129) onboard the vehicle 109 and/or other UE 111 in which the positioning receiver 105 is equipped to generate the dynamic mask angle 125. The real-time imagery data 127 can be processed to determine a line-of-sight to one or more positioning satellites 103. The elevation threshold of the dynamic mask angle 125 can then be dynamically adjusted to block or filter angles that are below the light-of-sight angle as the positioning receiver 105 or potentially obstructing surfaces, objects, etc. move within the geographic environment. Thus, the system 100 advantageously makes it possible to use a dynamic mask angle 125 to block out bounced signals 101 from the satellites 103 (e.g., multipath) which are the primary source of the urban canyon and obstruction problems.

The various embodiments described herein use a dynamic mask angle 125 because, it may not be enough to have a static unmoving mask angle. Accordingly, in one embodiment, as the conditions around a vehicle 109 or UE 111 change the GNSS dynamic mask angle 125 does too. For example, the dynamic mask angle 125 should increase when obstructions impinge (e.g., on the line-of-sight from the positioning receiver 105 to the satellites 103) and decrease when the obstructions fade. In some cases, a “learned” or dynamic mask angle can be generated using sensor data such as LiDAR modeling of the environment around the positioning receiver 105. However, this LiDAR approach is applicable only to vehicles 109 and/or UEs 111 that have onboard LiDAR sensors, which currently is not very widespread. To address this issue, the system 100 relies on real-time environmental data (e.g., real-time imagery data 127) that is generated from sensors (e.g., camera sensor 129) that are onboard a greater number of vehicles 109 or UEs 111.

In some scenarios, use of the dynamic mask angle 125 (e.g., particularly high-angle mask angles) may reduce the number satellites 103 visible to the positioning receiver 105 below a threshold number (e.g., minimum of four visible satellites 103) to achieve a target level of positioning accuracy or reliability. To address this issue, in one embodiment, the positioning receiver 105 can be configured to receive signals from multiple constellations of positioning satellites instead of just a single constellation. Examples of different constellations of GNSS satellites include but are not limited to those associated with the Global Positioning System (GPS), Global Orbiting Navigation Satellite System (GLONASS), Galileo, BeiDou, and/or the like. In this way, a positioning receiver 105 capable of receiving signals from multiple GNSS constellations can maximize the possible number of visible satellites 103 for generating positioning data 107 even when signals 101 from some of those satellites 103 are blocked or filtered by the dynamic mask angle 125.

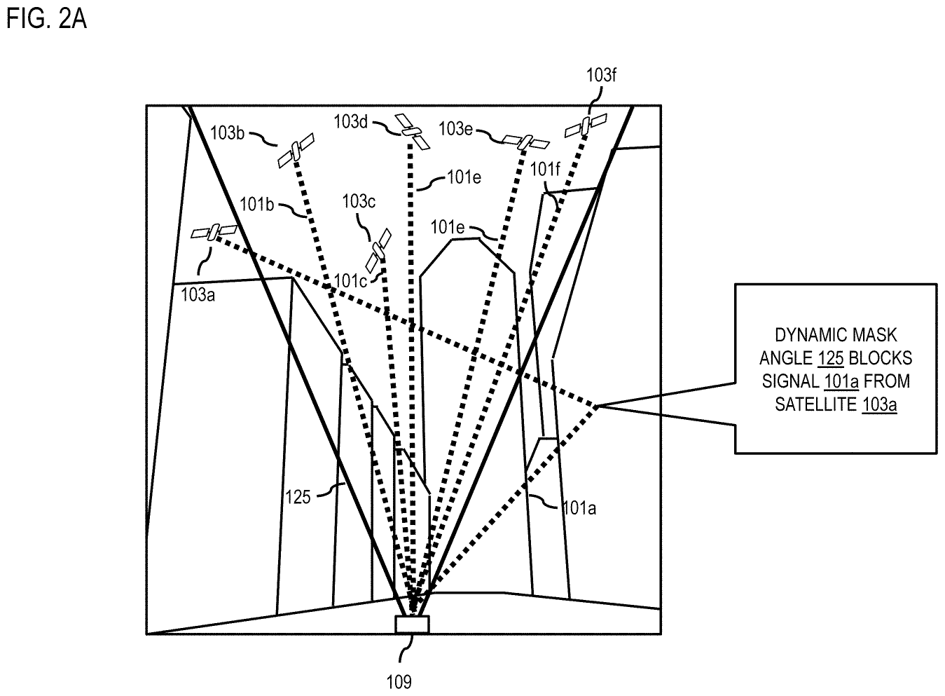

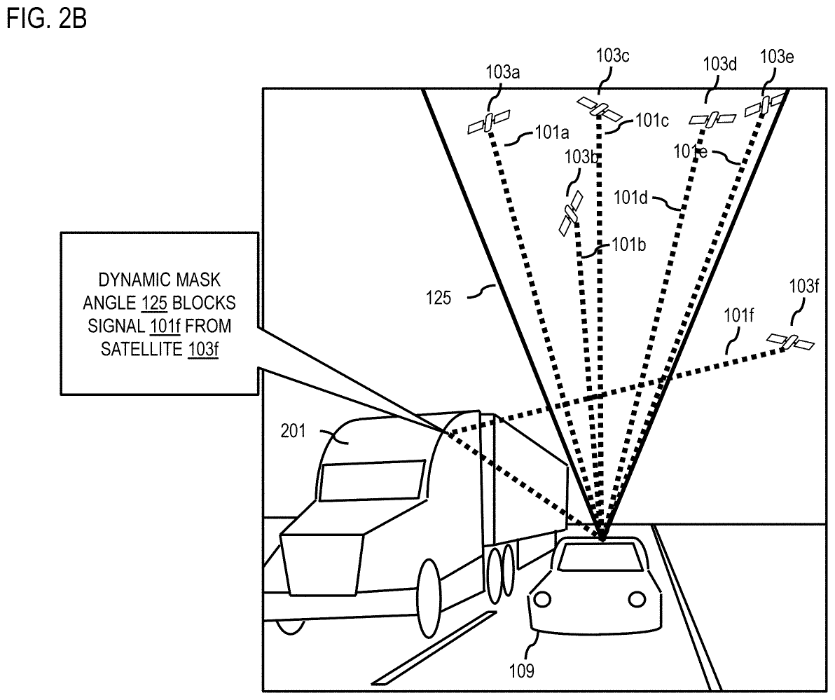

FIGS. 2A and 2B are diagrams illustrating examples of using a dynamic mask angle 125 to provide increased accuracy for a positioning receiver 105 in a multipath environment, according to one embodiment. In the example of FIG. 2A, a vehicle 109 equipped with a positioning receiver 105 (not shown) and a camera sensor 129 (not shown) is traveling in an urban environment. In this example, the camera sensor 129 of the vehicle 109 is used to capture a real-time image of the urban environment. The image is processed to determine surfaces, objects, and/or any other obstructions (e.g., buildings that are line-of-sight obstructions to the sky and/or any of the positioning satellites 103a-103f). Based on the determined obstructions or lines of sight, the system 100 can determine corresponding angles to generate a dynamic mask angle 125 that will block signals that are received at angles below the determined line of sight elevations. In this example, satellite 103a is blocked from a direct line of sight to the positioning receiver 105 of vehicle 109 by a building. Thus, the signal 101a from satellite 103a reaches the positioning receiver 105 only after bouncing off the surface of an adjacent building. Bounced signals are the primary cause of the urban canyon obstruction problem. Thus, the dynamic mask angle 125 generated based on the real-time imagery data 127 captured by an onboard vehicle camera sensor 129 can be used to block signal 101a from use in computing the positioning data 107 at the location.

However, the dynamic mask angle 125 generated in the example of FIG. 2A is optimized for that specific location of the vehicle 109 and positioning receiver 105. Thus, when the vehicle 109 moves to another location, the mask angle 125 may no longer be optimal (e.g., with respect to maximizing accuracy and maximizing the number of visible satellites 103 for use in positioning). In the example of FIG. 2B, the vehicle 109 has traveled out of the urban area of FIG. 2A to a highway. Satellites 103a-103f broadcasting respective signals 101a-101f are available in this environment. However, a large truck 201 has moved alongside the vehicle 109 creating a potential for a multipath signal environment. In this case, the side of the truck 201 creates a surface from which signal 101f from satellite 103f can be bounced before being received at the positioning receiver 105 of the vehicle 109. In addition, the positioning receiver has a direct line of sight to the satellite 103f so that there are at least two paths that signals from satellite 103f can reach the positioning receiver 103 (e.g., via signal 101f bounced off of the surface of the truck 201, or directly via a light of sight signal (not shown)). This creates a multipath problem that can decrease the accuracy and/or relatively of positioning data 107 generated in this scenario. Accordingly, the system 100 can capture real-time imagery data 127 depicting the truck 201 and any other nearby objects, surfaces, etc. that can bounce, block, or otherwise interface with signals 101a-101f originating satellites 103a-103f As described above, the real-time imagery data 127 can be processed to determine lines of sight to sky and/or satellites 103a-103f generate or update the dynamic mask angle 125 so that bounced signals (e.g., bounced signal 101f) can be blocked or filtered when computing positioning data 107 at the location, thereby increasing accuracy and reliability of the resulting positioning data 107. In one use case, the positioning data 107 generated according to the embodiments described herein can be matched against road links or other map features of a digital map (e.g., a geographic database 131) to identify specific road links/segments or other map features (e.g., points of interest, terrain features, political boundaries, etc.) corresponding to the raw geo-coordinates of the positioning data 107.

In one embodiment, the various embodiments for generating a dynamic mask angle 125 as described herein can be used with additional optional processes for increasing accuracy and/or reliability. Examples of these optional processes can include but are not limited to: (1) configuring the positioning receiver 105 to receive signals from multiple GNSS constellations or systems (e.g., GPS plus GLONASS plus Galileo, etc.) and not from just a signal constellation only (e.g., GPS only); (2) using a dynamic mask angle 125 in combination with differential correction' and/or the like. For example, increasing the number of supported GNSS constellations can increase the maximum elevation angle that can be used in the dynamic mask angle 125 while still maintaining a minimum number of visible satellites for computing the positioning data 107.

The various embodiments of the approach described herein provide for several technical advantages. For example, one traditional approach to generating a mask angle relies on Street View imagery (e.g., panoramic street view images captured by mapping vehicles at an earlier time) as opposed the real-time imagery data 127 used in the various embodiments described herein. For example, Street View imagery is static, by definition out of date and computationally difficult to process (e.g., the location of the car or positioning receiver 105 in each epoch was used to find the nearest previously stored Street View panorama to generate sky view images). Under the approach of the various embodiments described herein, this is all unnecessary. Instead, in one embodiment, the real-time imagery data 127 that is used to alter the dynamic mask angle 125 is captured by the vehicle 109 or UE 111 itself in real time so that the real-time imagery data 127 is dynamic and temporally correct. The alteration of the dynamic mask angle 125 can therefore be virtually instantaneous. Furthermore, there is no need to use an almanac to pre-plan the positions of the satellites for creating a mask angle. This is because the various embodiments of the system 100 are real-time system that work as efficiently in tree-obstructed areas as in an urban canyon and in traffic where a semi-trailer truck is beside the vehicle. There generally are not Street View or pre-stored imagery for those conditions.

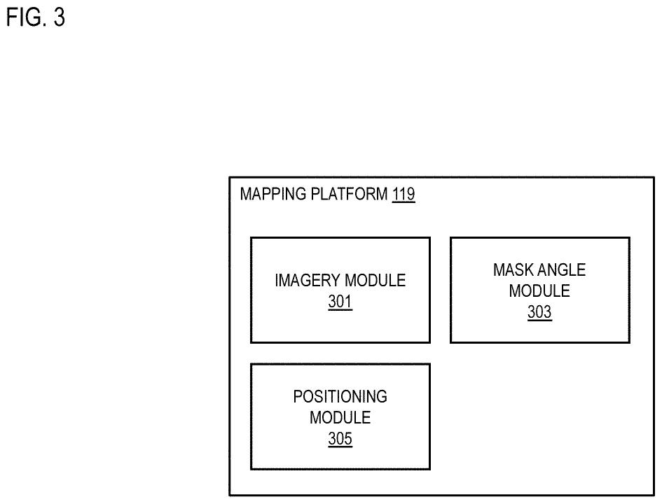

In one embodiment, the system 100 includes a mask angle application 123 or equivalent platform or module for performing one or more functions associated with providing increased accuracy for a positioning receiver in a multipath environment. FIG. 3 is a diagram of components of a mask angle application or platform, according to one embodiment. As shown, the mask angle application 123 includes an imagery module 301, a mask angle module 303, and a positioning module 305. The above presented modules and components of the mask angle application 123 can be implemented in hardware, firmware, software, or a combination thereof. Though depicted as a separate entity in FIG. 1, it is contemplated that the mask angle application 123 may be implemented as a module of any of the components of the system 100 (e.g., a component of the positioning receiver 105, vehicle 109, UE 111, application 113, services platform 117, services 119, content providers 121, and/or the like). It is also contemplated that the functions of the components of the mask angle application 123 may be combined or performed by other components or modules of equivalent functionality. In another embodiment, one or more of the modules 301-305 may be implemented as a cloud-based service, local service, native application, hardware, firmware, or combination thereof. The functions of the mask angle application 123 and modules 301-305 are discussed with respect to the figures below.

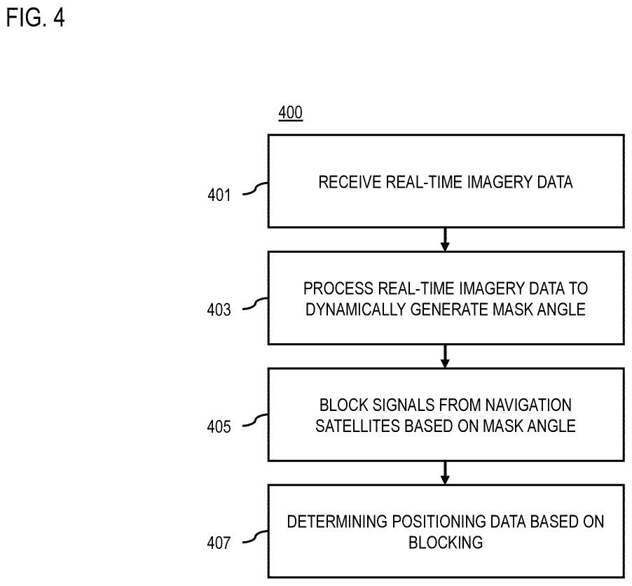

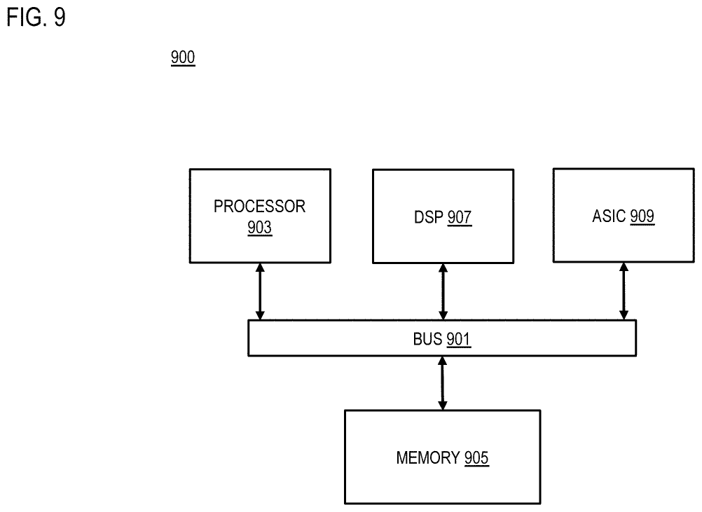

FIG. 4 is a flowchart of a process for providing increased accuracy for a positioning receiver in a multipath environment, according to one embodiment. In various embodiments, the mask angle application 123 and/or any of the modules 301-305 may perform one or more portions of the process 400 and may be implemented in, for instance, a chip set including a processor and a memory as shown in FIG. 9. As such, the mask angle application 123 and/or any of the modules 301-305 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the imagery module 301 receives real-time imagery data 127 collected using one or more sensors (e.g., camera sensors 129 or equivalent), wherein the real-time imagery data 127 depicts a geographic environment in which a positioning receiver 105 is operating. In one embodiment, the one or more sensors (e.g., camera sensors 129), the positioning receiver 105, or a combination thereof are equipped in a vehicle 109, a device (e.g., UE 111), or a combination thereof traveling in the geographic environment. In other words, the positioning receiver 105 and camera sensor 129 (or equivalent sensor capable of generating real-time imagery data 127) are co-located onboard a common device (e.g., UE 111 such as but not limited to a smartphone, personal navigation device, or equivalent) or vehicle 109 (e.g., car, truck, boat, bicycle, etc.).

In one embodiment, the real-time imagery data 127 is collected by the one or more sensors (e.g., camera sensor 129) at a location in the geographic environment corresponding to the positioning receiver 105. In this way, the captured real-time imagery data 127 will depict or correspond to the location and time at which the positioning receiver 105 is concurrently receiving positioning signals 101 from the satellites 103. In addition, the real-time imagery data 127 also enables the mask angle application 123 to continuously or periodically monitor the environment in which the positioning receiver 105 so that changes that may affect line of sight to the satellites 103 or other conditions affecting multipath possibilities for the signals 101 to reach the positioning receiver 105 can be monitored. For example, the monitoring can occur such that the real-time imagery can be capture at specified spatial and/or temporal intervals.

In step 403, the mask angle module 303 processes the real-time imagery data 127 to dynamically generate a mask angle (e.g., dynamic mask angle 125). Dynamic, for instance, refers a mask angle that can change in threshold elevation or angle for blocking bounced signals 101 based on changes in the environment. These changes can include but are not limited to changes resulting from movement of the positioning receiver 105 and/or the vehicle 109/UE 111 in which it is equipped, as well as changes in the movement or positions of nearby objects, surfaces, and/or any other feature capable of obstructing or reflecting signals 101 from the satellites 103.

As discussed above, in one embodiment, the dynamic mask angle 125 blocks the one or more signals 101 (e.g., broadcast from satellites 103) that are bounced off of one or more surfaces, one or more objects, or a combination thereof in the environment before being received by the positioning receiver 105. This bouncing or multipath signal propagation is one of the primary causes of the urban canyon or obstruction problem. According, the mask angle module 303 can process the real-time imagery data 127 to determine one or more respective positions of the one or more surfaces, the one or more objects, or a combination thereof relative to the positioning receiver, wherein the dynamic mask angle 125 is generated based on the determined one or more respective positions. In one embodiment, the dynamic mask angle 125 is generated based on at least one angle with respect to a line-of-sight from the positioning receiver 105 to sky or the satellites that is unobstructed by the one or more surfaces, the one or more objects, or a combination thereof as depicted in the real-time imagery data 127.

In one embodiment, the processing can be performed using computer vision or equivalent object recognition techniques that can segment and classify different sections into, for instance, sky versus non-sky regions. Then using properties of the camera sensor 129 (e.g., focal length, lens type, etc.), the mask angle can compute elevation angles from the horizon to the line of sight to an unobstructed view of the sky or satellites 103 from the perspective of the current location of the camera sensor 129 or positioning receiver 105. It is noted that the above example of generating the dynamic mask angle 125 from the real-time imagery data 127 is provided by way of illustration and not as a limitation. It is contemplated that any equivalent for extracting mask angles from imagery can be used according to the various embodiments described herein.

In step 405, the positioning receiver 205 blocks one or more signals 101 from one or more navigation satellites 103 received at the positioning receiver 105 using the dynamic mask angle 125. By way of example, the blocking refers to filtering or removing signals 101 that are received at the positioning receiver at an angle that is below the threshold angle or elevation specified in the dynamic mask angle 125. For example, if the dynamic mask angle has an angle of 60°, then any signals 101 arriving at the positioning receiver 105 at an incident angle of less than 60° will be blocked or filtered.

In one embodiment, the positioning receiver 105 is capable of receiving and processing positioning signals from more than one GNSS constellations to enable the positioning receiver to maximize the number of visible satellites 103 and positioning accuracy while also filtering or blocking some signals 101. Thus. the one or more navigation satellites 103 being used for positioning can belong to a plurality of different satellite constellations. By way of example, the different satellite constellations are Global Navigation Satellite Systems (GNSS) including but not limited to at least two of: (1) Global Positioning System (GPS); (2) Global Orbiting Navigation Satellite System (GLONASS); (3) Galileo; and (4) BeiDou Navigation Satellite System. The satellite constellations listed above are provided by way of illustration and not as limitations. It is contemplated that any equivalent GNSS (current or future) can be used according to the various embodiments described herein.

In step 407, the positioning module 305 determines positioning data 107 using the positioning receiver 105 based on the blocking of the one or more signals. For example, the positioning receiver 105 can compute the positioning data 107 (e.g., latitude, longitude, and/or altitude of the positioning receiver 105) based on the know locations of the satellites 103 (e.g., based on orbital data) and the difference in the arrival times of signals 101 received from a minimum number of satellites 103 (e.g., at least four satellites 103). The broadcasting of the signals 101 are synchronized among the satellites 103 (or otherwise known) such that the arrival times of their corresponding signals are associated with the relative distance of the positioning receiver 105 to each of the satellites 103 so that the positioning data 107 can be triangulated from the signals 101 that have not been blocked or filtered by the dynamic mask angle 125. In embodiments where the positioning receiver 105 is capable of using multiple satellite constellations for positioning, the positioning receiver 105 can have the orbital data and signal transmission synchronicity for the multiple constellations.

In one embodiment, the positioning data 107 can be differentially corrected to improve accuracy. For example, the differentially corrected positioning data 107 can be determined using Differential GPS (DGPS) (or any other equivalent positioning technology) that can improve location data accuracy (e.g., to meter-level accuracy or better). DGPS uses ground-based reference stations located at known locations that broadcast the difference between their known locations and their locations as determined from satellite signals. The difference (e.g., differences in the x, y, and z axes—3D location difference) can then be used to correct the location readings taken by nearby GPS receivers.

In one embodiment, the resulting positioning data 107 can be provided an output to a location-based service or application. The output can be in the form of raw geocoordinates (e.g., latitude, longitude, and/or altitude. In addition or alternatively, the output can include map matched data (e.g., matched to road links or features of a digital map such as the geographic database 131). As discussed above, the output can be used to by any location-based service or application such mapping, navigation, and/or the like.

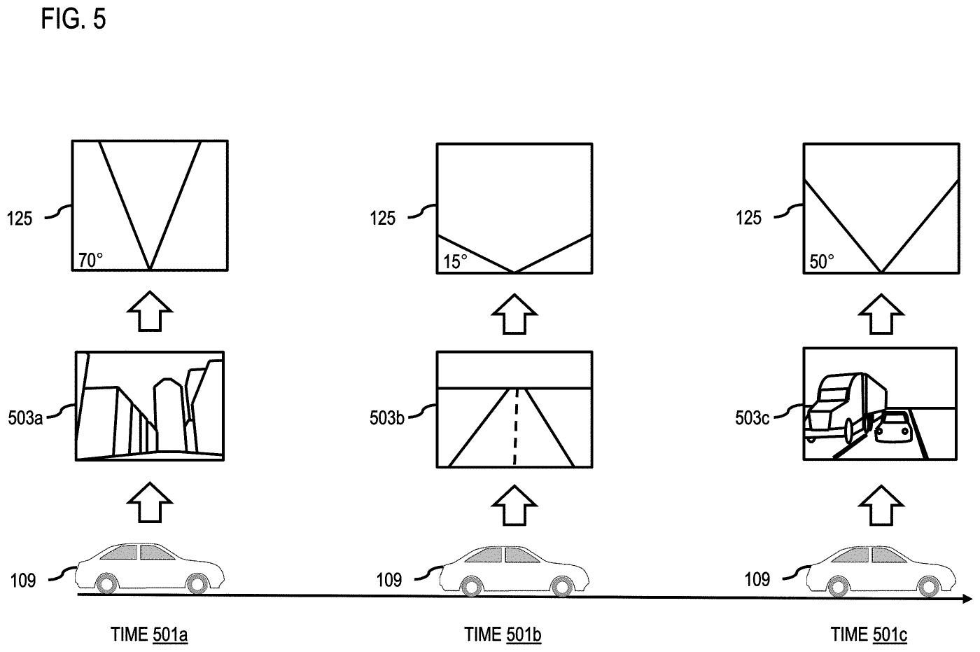

FIG. 5 is a diagram illustrating an example of generating a dynamic mask angle 125 for a positioning receiver 105 in a moving vehicle 109, according to one embodiment. In the example of FIG. 5, a vehicle 109 is equipped with a positioning receiver 105 (not shown) configured to generate a dynamic mask angle 125 based on real-time imagery data at time intervals (e.g., time 501a, time 501b, and time 501c) during a trip. At time 501a, the camera sensor 129 (not shown) of the vehicle 109 captures an image 503a of the surrounding geographic environment. The image 503a shows that the vehicle 109 is located in an urban center and is processed according to the embodiments described herein to generate the dynamic mask angle 125. Because the image 503a shows that the vehicle 109 is driving among tall buildings, the generated dynamic mask angle 125 is set at threshold angle or elevation of 70° indicating that the line of sight to the sky or satellites 103 is at a relatively steep angle. The positioning data 107 for the location of the vehicle 109 at time 501a is then generated using the dynamic mask angle 125 to block signals arriving at incident angles below 70°.

At time 501b, the vehicle 109 has traveled outside the urban center and is now in a more rural area. The camera sensor 129 of the vehicle 109 captures an image 503b showing that the terrain is relatively flat except for distant mountains on the horizon. The dynamic mask angle 125 is updated based on the new image 503b, resulting in an updated mask angle 125 with a threshold angle of 15°. This relatively low mask angle enables the positioning receiver 105 to dynamically take advantage of the more expansive view of the sky and increased number of satellites to generating positioning data 107 for the location of the vehicle 109 at time 50 lb.

At time 501c, a semi-trailer track is traveling next to the vehicle 109 and is obstructing more of the line of sight to overhead satellites 103. The camera sensor 129 captures an image 403c showing the truck next to the vehicle 109. The dynamic mask angle 125 is updated based on the new image 503c, resulting in an updated mask angle 125 that has been increased from 15° to 50° to avoid the obstruction between the positioning receiver 105 and some of the satellites 103. In this way, inaccuracies created by potential multipath interference created by the truck can be avoided to improve positioning accuracy and reliability.

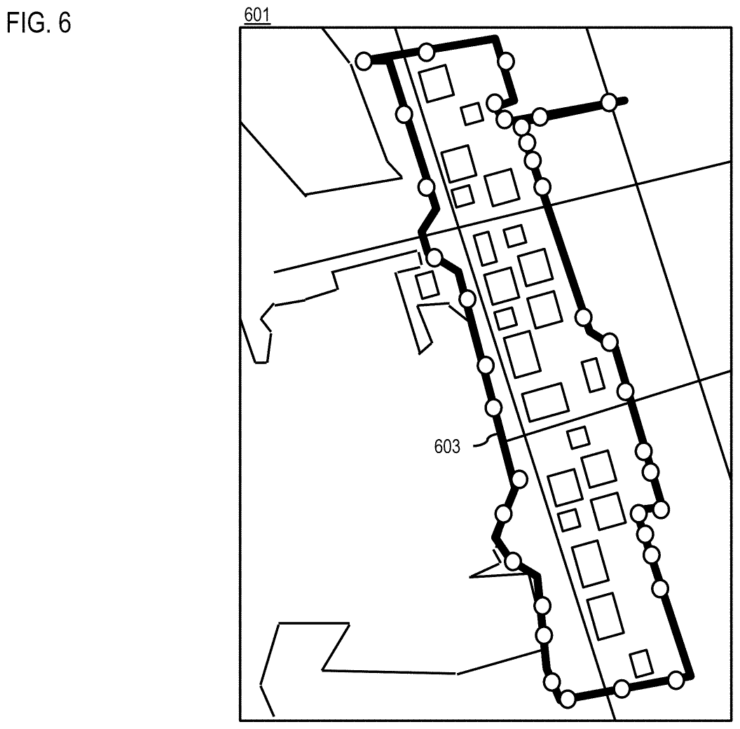

By enabling a dynamic mask angle 125, the system 100 provides for increased accuracy and consistency of positioning accuracy across a broader range of multipath environments. FIG. 6 is a diagram illustrating an example of mapping user interface presenting positioning data 107 generated using a dynamic mask angle 125, according to one embodiment. In the example of FIG. 6, a vehicle 109 is equipped with a positioning receiver 105 configured with a dynamic mask angle 125 generated according to the various embodiments described herein. A mapping user interface 601 depicts a map of a route 603 that is taken by the vehicle 109. Positioning data 107 is generated at multiple points (e.g., indicated by white dots) along the planned route 603 that takes the vehicle 109 through dense urban canyon areas as well as open spaces. By using the dynamic mask angle 125 to filter out potentially multipath signals 101, the resulting positioning data 107 shows that most of the white dots (e.g., indicating location data points determined by the positioning receiver 105) is consistently on the route 603 with little if no outlier points that are well off the route 603 (e.g., which might indicate positioning inaccuracy) even when traveling in urban canyon areas.

Returning to FIG. 1, as shown, the system 100 includes the mask angle application 123 for providing increased accuracy for a positioning receiver 105 in a multipath signal environment according to the various embodiments described herein. The mask angle application 123 also has connectivity or access to the geographic database 131 which stores digital map data in combination with the positioning data 107 generated according to the various embodiments described herein. In one embodiment, the geographic database 131 includes road link records and records of other map features that can be used to match against the generated positioning data 107 and/or to confirm the presence of obstruction, objects, surfaces, etc. detected in the real-time imagery data 127 from which the dynamic mask angle 125 is generated. As shown, the mask angle application 123 has connectivity over the communication network 115 to the services platform 117 that provides one or more services 119 that can use or provide data for generating the dynamic mask angle 125. By way of example, the services 119 may be third party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 119 uses the output of the mask angle application 123 to provide services 119 such as navigation, mapping, other location-based services, etc.

In one embodiment, the mask angle application 123 may be a platform with multiple interconnected components. The mask angle application 123 may include multiple servers, intelligent networking devices, computing devices, components, and corresponding software for providing the dynamic mask angle 125. In addition, it is noted that the mask angle application 123 may be a separate entity of the system 100, a part of the one or more services 119, a part of the services platform 117, or included within the UE 111 and/or vehicle 109. In one embodiment, content providers 121 (collectively referred to as content providers 121) may provide content or data for use according to the various embodiments described herein.

In one embodiment, the UE 111 and/or vehicle 109 may execute a software application 113 to capture sensor data (e.g., real-time imagery data 127) for providing the dynamic mask angle 125 according to the embodiments described herein. By way of example, the application 113 may also be any type of application that is executable on the UE 111 and/or vehicle 109, such as autonomous driving applications, mapping applications, location-based service applications, navigation applications, content provisioning services, camera/imaging application, media player applications, social networking applications, calendar applications, and the like. In one embodiment, the application 113 may act as a client for the mask angle application 123 and perform one or more functions associated with generating the dynamic mask angle 125 alone or in combination with the mask angle application 123.

By way of example, the UE 111 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 111 can support any type of interface to the user (such as “wearable” circuitry, etc.). In one embodiment, the UE 111 may be associated with the vehicle 109 or be a component part of the vehicle 109.

In one embodiment, the UE 111 and/or vehicle 109 are configured with various sensors for generating or collecting sensor data (e.g., real-time imagery data 127), related geographic data, etc. In one embodiment, the sensed data represent sensor data associated with a geographic location or coordinates at which the sensor data was collected. By way of example, the sensors may include a global positioning sensor for gathering location data (e.g., GPS or other GNSS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture ground control point imagery, etc. for analysis), an audio recorder for gathering audio data, velocity sensors mounted on steering wheels of the vehicles, switch sensors for determining whether one or more vehicle switches are engaged, and the like.

Other examples of sensors of the UE 111 and/or vehicle 109 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 111 and/or vehicle 109 may detect the relative distance of the vehicle from a lane or roadway, the presence of other vehicles, pedestrians, traffic lights, potholes and any other objects, or a combination thereof In one scenario, the sensors may detect weather data, traffic information, or a combination thereof. In one embodiment, the UE 111 and/or vehicle 109 may include GPS or other satellite-based receivers to obtain geographic coordinates for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mask angle application 123, services platform 117, services 119, UE 111, vehicle 109, and/or content providers 121 communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

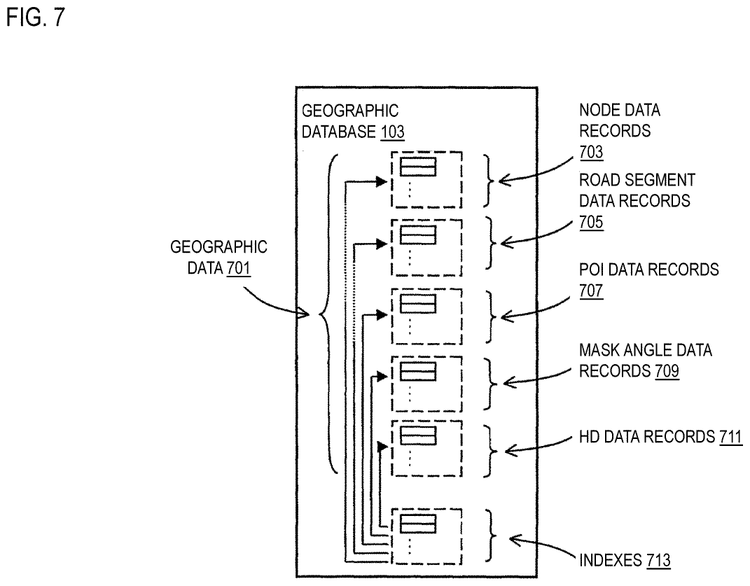

FIG. 7 is a diagram of a geographic database, according to one embodiment. In one embodiment, the geographic database 131 includes geographic data 701 used for (or configured to be compiled to be used for) mapping and/or navigation-related services, such as for video odometry based on the mapped features (e.g., lane lines, road markings, signs, etc.). In one embodiment, the geographic database 131 includes high resolution or high definition (HD) mapping data that provide centimeter-level or better accuracy of map features. For example, the geographic database 131 can be based on Light Detection and Ranging (LiDAR) or equivalent technology to collect billions of 3D points and model road surfaces and other map features down to the number lanes and their widths. In one embodiment, the HD mapping data (e.g., HD data records 711) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 131.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 131 follows certain conventions. For example, links do not cross themselves and do not cross each other except at a node. Also, there are no duplicated shape points, nodes, or links. Two links that connect each other have a common node. In the geographic database 131, overlapping geographic features are represented by overlapping polygons. When polygons overlap, the boundary of one polygon crosses the boundary of the other polygon. In the geographic database 131, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 131 includes node data records 703, road segment or link data records 705, POI data records 707, mask angle data records 709, HD mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 131. In one embodiment, the indexes 713 may be used to quickly locate data without having to search every row in the geographic database 131 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points corresponding to the respective links or segments of the road segment data records 705. The road link data records 705 and the node data records 703 represent a road network, such as used by vehicles, cars, and/or other entities. Alternatively, the geographic database 131 can contain path segment and node data records or other data that represent pedestrian paths or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 131 can include data about the POIs and their respective locations in the POI data records 707. The geographic database 131 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 131 can also include mask angle data records 709 for storing data related to generating dynamic mask angles 125 from real-time imagery data 127 according to the various embodiments described herein. By way of example, the mask angle data records 709 can be associated with one or more of the node records 703, road segment records 705, and/or POI data records 707 so specific dynamic mask angle 125 threshold elevation/angle data can be associated with corresponding positions at which the angle values were calculated.

In one embodiment, as discussed above, the HD mapping data records 711 model road surfaces and other map features to centimeter-level or better accuracy. The HD mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 711 are divided into spatial partitions of varying sizes to provide HD mapping data to vehicles 109 and other end user devices with near real-time speed without overloading the available resources of the vehicles 109 and/or devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 131 can be maintained by the content provider 105 in association with the services platform 117 (e.g., a map developer). The map developer can collect geographic data to generate and enhance the geographic database 131. There can be different ways used by the map developer to collect data. These ways can include obtaining data from other sources, such as municipalities or respective geographic authorities. In addition, the map developer can employ field personnel to travel by vehicle (e.g., vehicle 109 and/or UE 111) along roads throughout the geographic region to observe features and/or record information about them, for example. Also, remote sensing, such as aerial or satellite photography, can be used.

The geographic database 131 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 109 or UE 111, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a dynamic mask angle 125 based on real-time imagery data 127 may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

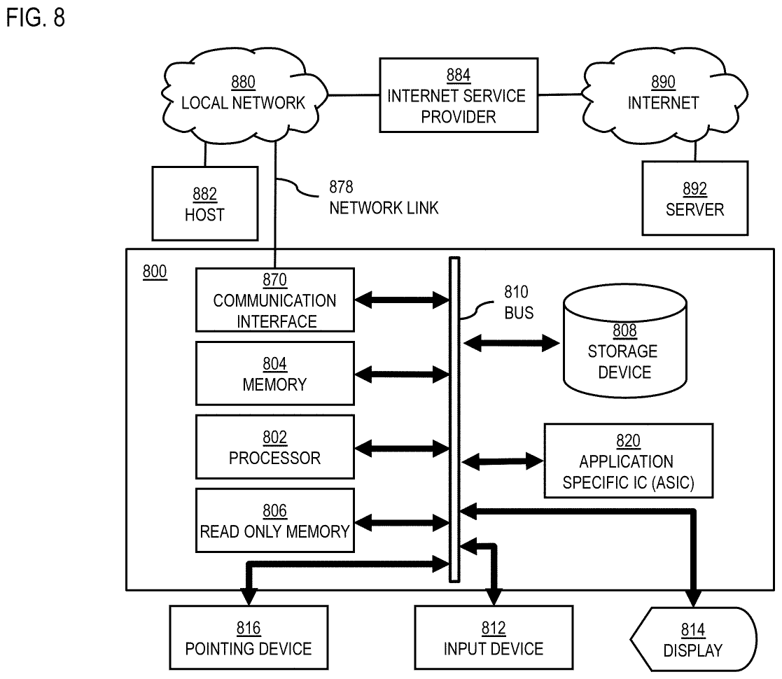

FIG. 8 illustrates a computer system 800 upon which an embodiment of the invention may be implemented. Computer system 800 is programmed (e.g., via computer program code or instructions) to provide a dynamic mask angle 125 based on real-time imagery data 127 as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing a dynamic mask angle 125 based on real-time imagery data 127. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing a dynamic mask angle 125 based on real-time imagery data 127. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing a dynamic mask angle 125 based on real-time imagery data 127, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives, or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 115 for providing a dynamic mask angle 125 based on real-time imagery data 127.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to provide a dynamic mask angle 125 based on real-time imagery data 127 as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a dynamic mask angle 125 based on real-time imagery data 127. The memory 905 also stores the data associated with or generated by the execution of the inventive steps.

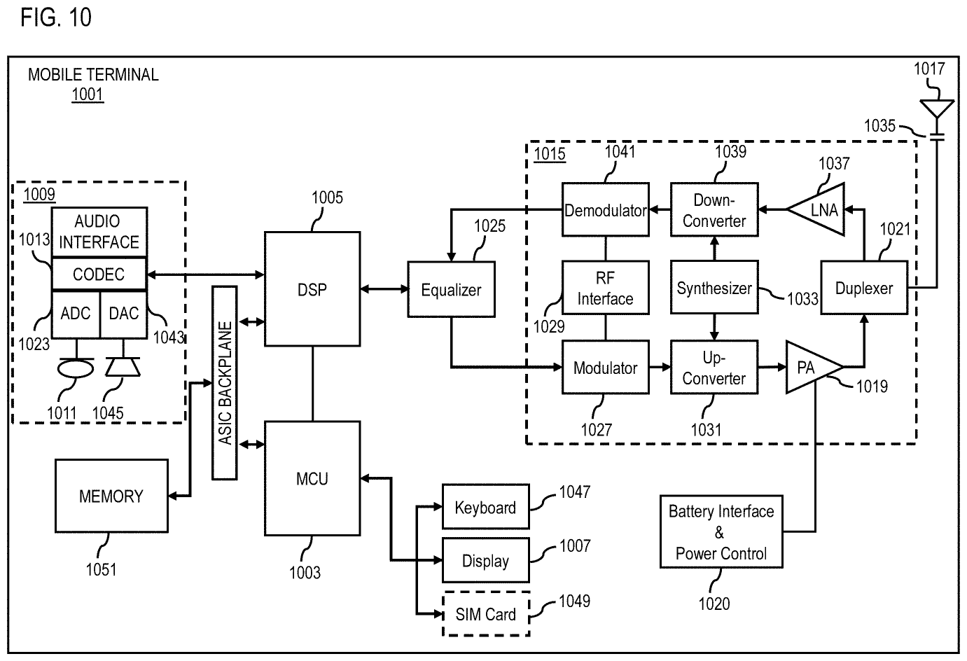

FIG. 10 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide a dynamic mask angle 125 based on real-time imagery data 127. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving real-time imagery data collected using one or more sensors, wherein the real-time imagery data depicts a geographic environment in which a positioning receiver is operating;
processing the real-time imagery data to dynamically generate a mask angle;
blocking one or more signals from one or more navigation satellites received at the positioning receiver using the mask angle; and
determining positioning data using the positioning receiver based on the blocking of the one or more signals.

2. The method of claim 1, wherein the one or more sensors, the positioning receiver, or a combination thereof are equipped in a vehicle, a device, or a combination thereof traveling in the geographic environment.

3. The method of claim 1, wherein the real-time imagery data is collected by the one or more sensors at a location in the geographic environment corresponding to the positioning receiver.

4. The method of claim 1, wherein the mask angle blocks the one or more signals that are bounced off of one or more surfaces, one or more objects, or a combination thereof in the environment before being received by the positioning receiver.

5. The method of claim 4, further comprising:
processing the real-time imagery data to determine one or more respective positions of the one or more surfaces, the one or more objects, or a combination thereof relative to the positioning receiver,
wherein the mask angle is generated based on the determined one or more respective positions.

6. The method of claim 4, wherein the mask angle is generated based on at least one angle with respect to a line-of-sight from the positioning receiver to sky that is unobstructed by the one or more surfaces, the one or more objects, or a combination thereof as depicted in the real-time imagery data.

7. The method of claim 1, wherein the one or more navigation satellites belong to a plurality of different satellite constellations.

8. The method of claim 7, wherein the different satellite constellations are Global Navigation Satellite Systems (GNSS).

9. The method of claim 8, wherein the GNSS include at least two of:
Global Positioning System (GPS);
Global Orbiting Navigation Satellite System (GLONASS);
Galileo; and
BeiDou Navigation Satellite System.

10. The method of claim 1, further comprising:
providing the positioning data as an output to a location-based service.

11. An apparatus comprising:
at least one processor; and
at least one memory including computer program code for one or more programs,
the at least one memory and the computer program code configured to, with the at least one processor, cause the apparatus to perform at least the following,
receive real-time imagery data collected using one or more sensors, wherein the real-time imagery data depicts a geographic environment in which a positioning receiver is operating;
process the real-time imagery data to dynamically generate a mask angle;
block one or more signals from one or more navigation satellites received at the positioning receiver using the mask angle; and
determine positioning data using the positioning receiver based on the blocking of the one or more signals.

12. The apparatus of claim 11, wherein the one or more sensors, the positioning receiver, or a combination thereof are equipped in a vehicle, a device, or a combination thereof traveling in the geographic environment.

13. The apparatus of claim 11, wherein the real-time imagery data is collected by the one or more sensors at a location in the geographic environment corresponding to the positioning receiver.

14. The apparatus of claim 11, wherein the mask angle blocks the one or more signals that are bounced off of one or more surfaces, one or more objects, or a combination thereof in the environment before being received by the positioning receiver.

15. The apparatus of claim 14, wherein the apparatus is further caused to:
process the real-time imagery data to determine one or more respective positions of the one or more surfaces, the one or more objects, or a combination thereof relative to the positioning receiver,

16. A non-transitory computer-readable storage medium carrying one or more sequences of one or more instructions which, when executed by one or more processors, cause an apparatus to perform:
receiving real-time imagery data collected using one or more sensors, wherein the real-time imagery data depicts a geographic environment in which a positioning receiver is operating;
processing the real-time imagery data to dynamically generate a mask angle;
blocking one or more signals from one or more navigation satellites received at the positioning receiver using the mask angle; and
determining positioning data using the positioning receiver based on the blocking of the one or more signals.

17. The non-transitory computer-readable storage medium of claim 16, wherein the one or more sensors, the positioning receiver, or a combination thereof are equipped in a vehicle, a device, or a combination thereof traveling in the geographic environment.

18. The non-transitory computer-readable storage medium of claim 16, wherein the real-time imagery data is collected by the one or more sensors at a location in the geographic environment corresponding to the positioning receiver.

19. The non-transitory computer-readable storage medium of claim 16, wherein the mask angle blocks the one or more signals that are bounced off of one or more surfaces, one or more objects, or a combination thereof in the environment before being received by the positioning receiver.

20. The non-transitory computer-readable storage medium of claim 19, wherein the apparatus is caused to further perform:
processing the real-time imagery data to determine one or more respective positions of the one or more surfaces, the one or more objects, or a combination thereof relative to the positioning receiver,
